(19) United States
(12) Patent Application Publication
(10) Pub. No.: US 2009/0103280 A1
(43) Pub. Date: Apr. 23, 2009

(54) Screen Supporting Device Provided With Screen Illuminating Light Sources

(75) Inventors: Yvan Peard, Antony (FR); Florent Francois, Orsay (FR); Christophe Benoist, Linars (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Ayrton, Longjumeau (FR)

(21) Appl. No.: 11/887,855

(22) PCT Filed: Feb. 23, 2006
(86) PCT No.: PCT/FR2006/000407

§ 371 Date: Dec. 19, 2008

(30) Foreign Application Priority Data
Apr. 5, 2005 (FR) 0503355

(51) Int. Cl. G09F 13/08

(52) U.S. Cl. 362/97.1

(57) ABSTRACT

A device for displaying an image has a screen, a support structure with support elements for supporting the screen, and a plurality of light sources. Each support element is in contact with the screen at a contact area. Each light source illuminates an illuminated area on the screen. The light sources are positioned such that illuminated areas generated by light sources adjoining one another are overlapping and thus create an overlapping area. The contact areas between support elements and the screen are superimposed on the overlapping areas.

The present invention relates to a device for displaying an image including a screen supported by a support structure. More particularly, the present invention relates to a device including a support structure, comprising support elements for supporting said screen, whereby each of said support element is in contact with said screen in a contact area, said device also comprising light sources, each of which illuminates an illuminated area on said screen.

There is a demand for diffusing an image onto surfaces used as a stage for a show or as a dance floor. Very thick glass panels are used to bear the weight of the dancers. Screens, such as liquid crystal displays screens (LCD screens) are arranged in abutment with one another underneath this transparent glass, whereby the image shown on these screens is visible through the large glass panel. It is not possible to mount support elements in the middle of the image, right underneath the glass panel, as the image would then have a hole and it would be very difficult to adjust the image between the various LCD screen panels. To overcome this, the panels are supported only on their edges and are sized and shaped according to the relevant location. The larger the location, such as a stage for a show or a dance floor, the thicker the panel will need to be. The drawback is that such an arrangement is unique and only conforms to its relevant location. Moreover, the larger the location to be covered by the surface is, the more difficult and costly such an arrangement will be to set up.

The aim of the present invention is therefore to be able to use a device allowing the creation of a surface for the projection of an image or a video, which can be adapted to show stages or floors of various sizes and various shapes and which does not necessitate the use of very thick glass panels without any possibility of supporting them where the image is shown.

The object of the present invention is therefore a device for displaying an image according to the introduction, wherein said light sources are positioned so that said illuminated areas generated by light sources adjoining one another are overlapping and thus create an overlapping area, the contact areas between said support elements and said screen being superimposed on said overlapping areas. Therefore, according to the present invention, when the light sources illuminate said screen, only their light will be visible and the contact area will thus be concealed or softened by the light intensity of the sources.

Preferably, said screen includes a light diffusion means for diffusing the light emitted by said light sources such that each illuminated area thus consists of a central illumination area surrounded by a diffusion halo and is created at said diffusion level. This allows precise light dots to be viewed on the diffusion means. These dots correspond to the central illumination area. This allows one pixel of the displayed image to be defined. The diffusion halos allow visual transitions to be performed between each of the pixels.

Preferably, said screen includes a transparent portion having a thickness e, situated between said support element and said light diffusion means. This transparent portion allows the extent of the diffusion on the diffusion means to be increased.

Preferably, said thickness e of said transparent portion is less than a value eₘₐₓ given by the following relation:

eₘₐₓ=(l+L)cotan(α/2)−h

wherein

h is the shortest distance between the light sources (2, 3, 4 and 5) and said transparent portion (6),

L is the distance between each support element (12) and the nearest light sources (2, 3, 4 and 5),

l is the distance between the middle and the edge of said contact area, and

α is the direct illumination angle of said light sources.

Therefore, the overlapping area which is superimposed on the contact area is obtained only by the diffusion halos overlapping, with the direct illumination beams not overlapping. This allows overlapping of the pixels to be prevented, while the contact areas are concealed by the diffusion halos overlapping.

Preferably, said transparent portion is a transparent element, such as glass or Plexiglas, including a first and a second face, with said contact areas being on said first face, and said diffusion means is a translucent element, such as a rear projection cloth, situated on said second face of said transparent element. This allows common rear projection cloths to be used for the present invention, by pasting them, for example, onto a glass panel.

Preferably still, said device includes a second transparent element, whereby said diffusion means is situated between said first transparent element and said second transparent element. This allows said diffusion means to be protected against impacts or dirt.

According to a preferred embodiment, said device includes at least one holding means for holding said light sources, said holding means being situated at a distance d from said support elements and at a distance d′ from said screen, thus defining a space between said holding means and said support elements, and between said holding means and said screen, such that the vibrations of said screen are not transmitted to said light sources directly or via said support elements.

Preferably, said holding means for holding said light sources is a panel including said light sources, said panel including through holes for said support elements to pass therethrough.

According to another preferred embodiment, the device is in the shape of a box including walls. This allows all of the light sources to be protected during transport or installation. This also allows several devices to be abutted side by side, in order to cover a surface by means of several devices according to the present invention.

Preferably, said walls include at least one passage to allow cables to pass therethrough.

According to another preferred embodiment, said device includes a control means allowing the parameters of the light emitted by said light sources to be controlled. Notably, this allows said device for displaying an image or part of an image to be controlled.

Preferably, the structure of the device according to the present invention comprises partitions allowing said control means to be separated from the rest of the device.

According to another preferred embodiment, said device comprises connection means for connecting said device to at least one other device according to the present invention.

A second object of the present invention is an assembly of at least two devices according to the present invention, the devices being in abutment such that the edge of one of the devices is adjacent to the edge of the other device, such that the screens of both devices constitute a composite screen, the surface of which corresponds to the sum of the surfaces of each screen of each device.

According to a preferred embodiment of the second object according to the present invention, said assembly includes a global control means, connected to all of the devices of said assembly for controlling all of said devices for projecting an image onto said composite screen.

The aims, objects and features of the present invention will become more apparent when reading the following description with reference to the drawings in which,

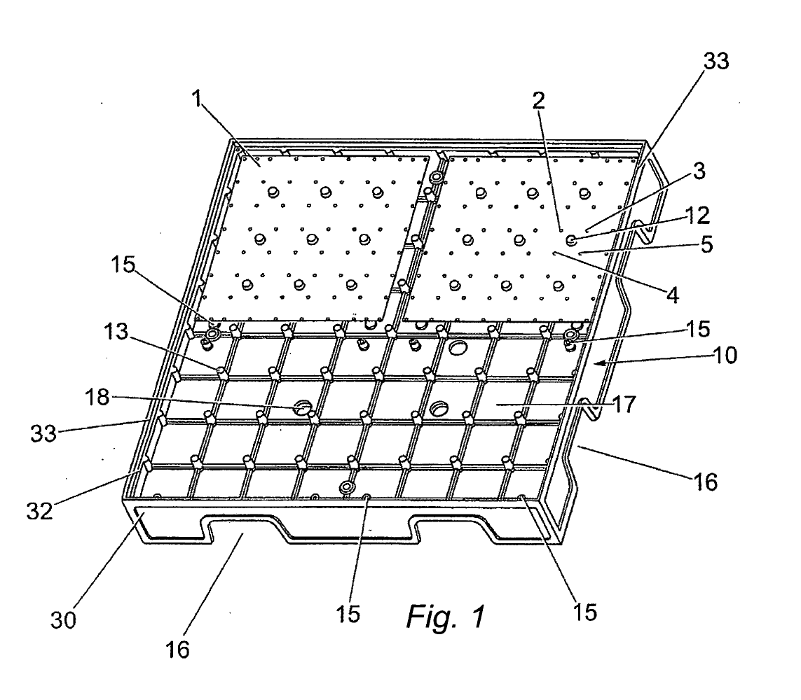

FIG. 1 is a perspective view of part of the device according to the invention,

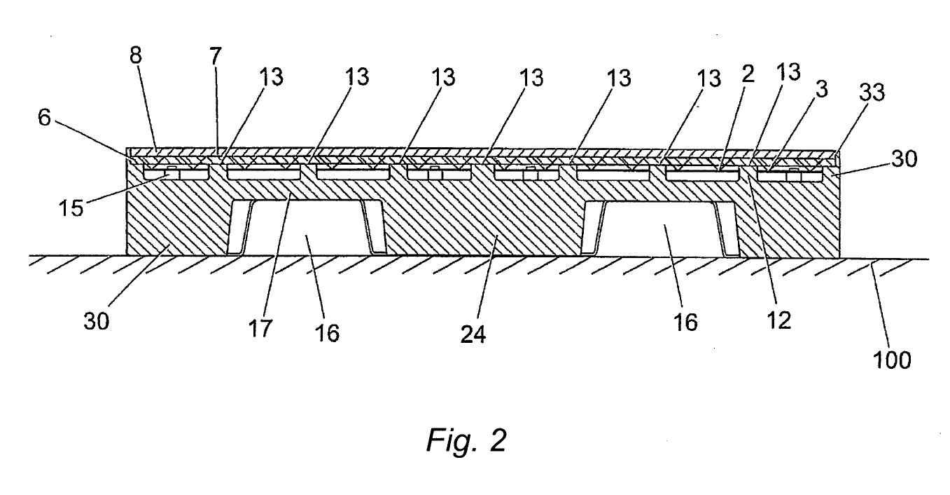

FIG. 2 is a cross section of the device according to the invention,

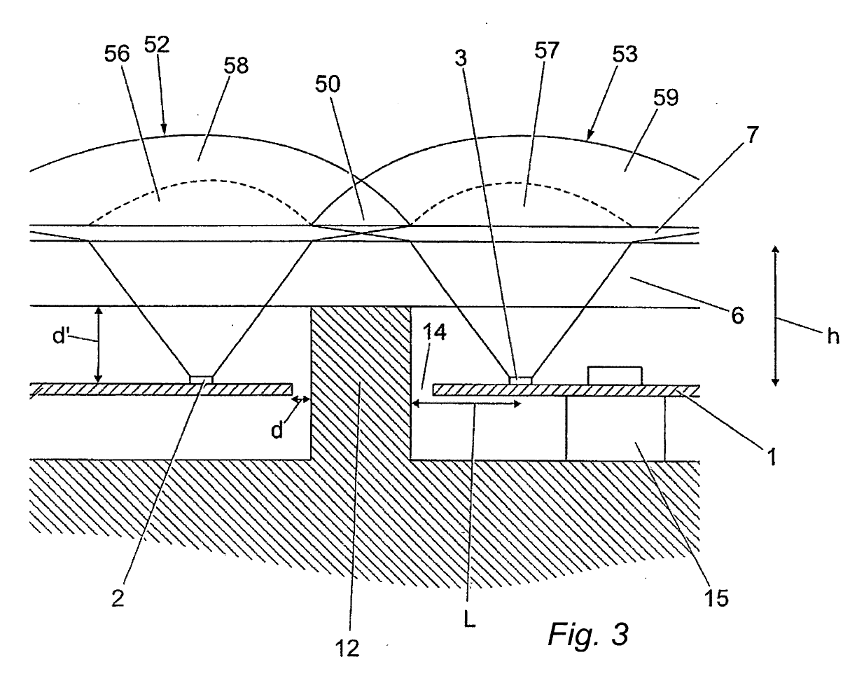

FIG. 3 is a detailed cross-section view of the device according to the invention,

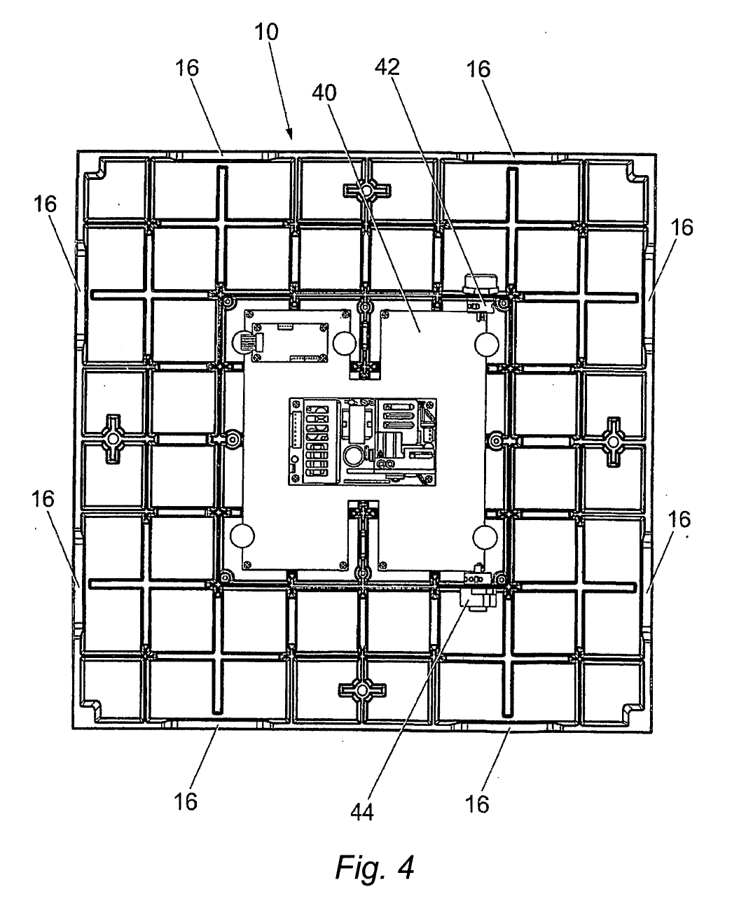

FIG. 4 is a bottom view of the device according to the invention.

As represented in FIG. 1, the device includes a structure 10 comprising support elements 12. For clarity, the screen and the cables have not been represented on this FIG. 1. The device also includes light sources 2, 3, 4 and 5 which are supported by at least one holding means 1. Preferably, this holding means 1 is a panel which includes said light sources 2, 3, 4 and 5. This panel has holes for the support elements 12 to pass therethrough. Preferably, the panel 1 is supported by support means 15 such as pins for instance, as shown in FIG. 1. Preferably, said panel 1 is attached to said support means 15. FIG. 1 shows two holding means 1. Preferably, all of the holding means 1 or the holding means (when there is only one) cover the whole of the device. For clarity's sake, only half of the device in FIG. 1 is covered by the holding means 1 and therefore by light sources. Preferably, the holding means is a printed circuit to which the light sources 2, 3, 4 and 5 are connected.

Preferably, the light sources are evenly distributed. As represented in FIG. 1, each support means 12 is surrounded by a group of light sources, corresponding to the nearest light sources 2, 3, 4 and 5. Preferably, the light sources of this group are each equally spaced from the support element 12.

The device according to the present invention includes walls 30 and 17. In the preferential example shown in FIG. 1, the device is in the shape of a box and includes a wall 30 on each of its edges and a panel 17. The edges 30 will allow the sides of the device and particularly the illumination means which include the light sources 2, 3, 4 and 5 to be protected. The panel 17 also allows the bottom of these illumination means to be protected. The panel 17 comprises at least one passage 18 for allowing cables to pass therethrough. Also, the walls 30 comprise passages 16 for allowing cables to pass therethrough. These cables are for instance connection cables for powering the light sources 2, 3, 4 and 5. It should be noted that for clarity's sake, only one support element has been given the reference numeral 12, and only the group of light sources 2, 3, 4 and 5 surrounding this support element has also been referenced. However, the comments pertaining to this support element 12 and to these light sources 2, 3, 4 and 5 apply by extension to all of the other support elements and light sources surrounding these, which are shown in the present FIG. 1. Preferably, the walls 30 further include a ledge 32 and/or a border 33, preferably extending the whole of the length of the wall 30 and inside the device. The height of the ledge 32 is the same as that of the support elements 12.

FIG. 2 shows a cross-sectional view of the device according to the present invention. The section has been made along an axis extending through the middle of the support elements 12. The screen 9 is supported by the support elements 12. The portion of the screen 9 that is in contact with the support element 12 is defined as the contact area 13. Preferably, the support element 12 is in the shape of a pin with a flat top. As shown in FIG. 2, this flat top is wholly in contact with said screen 9 and therefore corresponds to said contact area 13.

Preferably, the screen 9 is made up of a transparent portion 6 which has a thickness e. By transparent, we mean a material which lets the light through and allows the objects to be clearly distinguished through its thickness. The first face of this transparent portion 6 is in contact with the support elements 12 at the contact areas 13. The screen 9 also includes a diffusion means 7 at the second face of said transparent portion 6. Thus, the light sources 2, 3 will illuminate the diffusion means 7 through the transparent portion 6. An illuminated area will thus be created on the diffusion means. This area will be made up of a central illumination area corresponding to the direct illumination of the diffusion means by the light sources and a diffusing halo around the central illumination area. This diffusing halo is created by the diffusion means. For instance, the transparent element 6 may be a glass panel whose second face has been sand blasted, thereby diffusing light. In this case, the second face of transparent element 6 constitutes the diffusion means.

Preferably, the transparent portion is a transparent element, such as a transparent glass panel, and the diffusion means 7 is a translucent element, such as a rear projection cloth situated on said second face of said transparent element 6. By translucent, we mean a material that lets the light through, but does not allow the outline of objects to be clearly distinguished through its thickness.

Preferably, a second transparent element 8 is placed on the other side of the diffusion means 7. The diffusion means 7 is thus situated between the first transparent element 6 and the second transparent element 8. This second transparent element allows the diffusion means 7 to be protected. Consequently, in view of FIGS. 1 and 2, it appears that when the screen is arranged on the structure 10, the light sources 2, 3, 4 and 5 and their holding means 1 are enclosed within the edges 30, the screen 9 and the panel 17. Preferably, when the transparent elements 6 and 8 are made of glass, they are of the same thickness, which allows the strength of the screen 9 to be increased.

Preferably, the ledge 32 allows said screen to be further supported. The border 33 allows the closure of the box made up by said structure 10 by means of the screen 9 to be adjusted. Said structure 10 preferably includes partitions 24.

Preferably and as is shown in FIG. 2, the support elements 12 extend to a large extent directly to the support surface 100 on which said device is supported. Thus, the forces which will be applied to the screen 9 towards said support surface 100 will be distributed on all of the support elements 12 and will be transmitted directly to the support surface 100. This makes it possible to reinforce the strength of said device by lightening the stresses at the screen 9.

FIG. 3 highlights the operation of the present invention. It is an enlarged representation of one of the support elements 12 as shown in FIG. 2. As it is a cross sectional view through the support element 12, only two light sources 2 and 3 are visible. For simplicity's sake, the second transparent element 8 has not been shown. The light sources 2 and 3 generate a light beam which will illuminate the diffusion means 7. The light source 2 generates an illuminated area 52 and the light source 3 generates an illuminated area 53. According to the present invention and as shown in FIG. 3, these illuminated areas 52 and 53 overlap each other and thus create an overlapping area 50. According to the present invention, the contact area 13 is superimposed on the overlapping area 50. Thus, the contact area 13 will not be visible or will hardly appear at the illuminated areas 52 and 53.

In FIG. 3, an arc of circle is shown in dotted lines inside each illuminated area 52 and 53. The central illumination area 56 or 57 within this circle in dotted lines corresponds to the direct illumination of the diffusion means 7 by the corresponding light source 2 or 3. The light emitted by said light source 2 or 3 goes through the transparent element 6 and reaches directly the diffusion means 7. This brightness is however diffused by the diffusion means 7 on the sides of the central illumination areas 56 and 57, such that a diffusion halo 58 or 59 surrounds each central illumination area 56 or 57, which widens the illuminated area 52 or 53. This corresponds to a diffusion illumination and corresponds, in FIG. 3, to the area comprised between the edge in full lines of each illuminated area 52 or 53 and the arc of circle in dotted lines. Thus, each central illumination area 56 or 57 can constitute one dot of the image displayed on the screen, namely it can correspond to a pixel. The diffusion halos 58 and 59 constitute in this case a transition from one pixel to another. In FIG. 3, it is to be noticed that the diffusion halos 58 and 59 allow the creation of an overlapping area 50, the size of which is preferably equal to or bigger than the contact area 13, in order to obtain a superimposition allowing the contact area 13 to be concealed.

Preferably, the thickness e of the transparent element 6 will allow the diffusion to be increased. Indeed, the direct illumination beam of a light source is not limited in a strict manner. In general, a light source, such as a light emitting diode, is defined as having a direct illumination angle α. The light beam comprised within this angle corresponds to a percentage of brightness, which is defined in relation to the total brightness of the source, generally higher than 50%. The beam comprised within this angle is defined as being the direct illumination beam. However, outside this angle, there exists some brightness. The thickness e will allow this brightness outside the direct illumination beams emitted by the light sources 2 and 3 to pass between the contact area 13 and the diffusion means 7, thereby extending the diffusion halos 58 and 59.

Preferably, the overlapping area 50 is totally superimposed on the contact area 13 and thus it has a size which is bigger than or equal to that of this contact area 13.

Preferably still, the central illumination areas 56 and 57 do not overlap. Thus, when each of the central illumination areas 56 and 57 corresponds to one dot making up the image which is displayed on the screen, that is when the illuminated areas 56 and 57 each correspond to one pixel, the image is clearer because the pixels do not mix. In such a case, the thickness e of the transparent element 6 is less than or equal to a value eₘₐₓ given by the following relation:

eₘₐₓ=(l+L)cotan(α/2)−h

wherein:

h is the shortest distance between the light sources 2, 3, 4 and 5 and said transparent portion 6,

L is the distance between each support element 12 and the nearest light sources 2, 3, 4 and 5,

l is the distance between the middle and the edge of said contact area, and

α is the direct illumination angle of the light sources 2, 3, 4 and 5.

Thus, the overlapping area 50 is made up by the overlapping only of the diffusion halos 58 and 59. These halos allow therefore the transition from one central illumination area 56 to a central illumination area 57 and the concealment of the contact element 13.

Consequently, according to the present invention, when the light sources 2, 3, 4 and 5 illuminate said diffusion means 7, only the light from these light sources will be visible and the contact area 13 will thus be concealed or softened depending on the light intensity of the sources. This will make it possible to increase the number of support elements 12 in the device for supporting the screen 9, without corrupting the image or the light intensity projected on the whole of the screen 9. Preferably, each support element 12 is surrounded by four light sources 2, 3, 4 and 5.

Another advantage of this invention is that in making it possible to increase the number of support elements 12, said invention allows the screen 9 to bear stresses applying towards the support surface 100, with all of these stresses being distributed on all of the support elements 12. Depending on the intensity of the stresses the screen 9 will be subjected to, increasing the number of support elements 12 by as much will suffice.

Preferably, the holding means 1 is situated at a distance d from the support element 12 and at a distance d′ from the screen 9. It thus defines a space 14 situated between the support element 12 and the holding element 1 and between the screen 9 and the holding element 1. Consequently, the vibrations the screen 9 will be subjected to will not directly be transmitted from the screen 9 to the holding means 1 or from the support element 12 to the holding means 1. This will make it possible to lessen the vibrations at the light sources directly or via the support elements 12. Preferably, when the holding means 1 is a panel, the latter includes holes for the support elements 12 to pass therethrough, the edges of which are not in contact with the support elements 12. As shown in FIG. 3, the support element 12 is a pin whose diameter at the panel 1 is smaller than the hole through which it passes.

Preferably, the support element 15 will include an elastic means in contact with panel 1 in order to avoid transmission of the vibrations to the panel 1 via said holding means 15.

FIG. 4 shows a bottom view of the device according to the present invention. Preferably, said device includes a control means 40 for controlling the parameters of the light emitted by said light sources 2, 3, 4 and 5. This control means will make it possible to control the light intensity of each of the light sources 2, 3, 4 and 5, or still, the colour emitted by these. It will therefore be possible to diffuse an image on the screen 9 of said device, each light source corresponding to one pixel of the image shown on the screen 9. Preferably, the light sources 2, 3, 4 and 5 are light emitting diodes (LED).

Preferably, the device includes partitions 24 enabling the separation of said control means 40 from the rest of the device as is shown in FIGS. 1, 2 and 4. The panel 17 will make it possible to separate the control means 40 from the light sources 2, 3, 4 and 5. The holes 18 will allow the means for connecting the light sources to the control means 40 to pass therethrough.

Preferably, said device includes connection means 42 and 44 for enabling it to be connected to another device according to the present invention. As shown in FIG. 4, the connection means 42 and 44 will allow cables for connecting said device to be connected. For clarity's sake, these cables have not been shown in FIG. 4. When said device is in the shape of a box, passages 16 inside the edges 30 allow the cables or the electric connections to pass therethrough in order to join them to the connection means 42 and 44. In FIG. 4, these connection means 42 and 44 are directly joined to the control means 40.

The connection of two devices according to the present invention makes it possible to create an assembly made of at least two devices. The two devices are then preferably in abutment such that the edge of one of the devices is adjacent to the edge of the other device. Consequently, the two screens of the two devices will constitute a composite screen, the surface of which corresponds to the sum of the surfaces of each screen of each device.

Preferably, the assembly described previously is joined to a global control means which is connected to all of the devices of the assembly for controlling all of the devices. This global control means will make it possible to control all of the light sources of each of the devices and therefore to project an image onto the composite screen. The present invention will therefore make it possible to create a composite screen the size of which can be adjusted. The surface of the composite screen will be a function of the number of devices chosen.

Therefore, the present invention makes it possible to produce adjustable screens which may be supported on a support surface 100. For instance, it may be a dance floor on which said devices will be arranged, in abutment with each other. A floor able to bear the weight of a large number of people will thus be obtained. This floor will constitute a screen for diffusing an image. The weight of the dancers will be distributed on all of the support elements 12. Depending on the weight the whole of this floor will have to bear, the devices will include more or less support elements 12, which the present invention enables to conceal.

In such a case, the screen preferably includes two transparent elements 6 and 8 as previously described, said transparent elements being made of, for instance, panels of laminated sheet glass or Plexiglas.

1. A device for displaying an image including:
a screen,
a support structure, comprising support elements for supporting said screen, whereby each of said support elements is in contact with said screen in a contact area,
light sources, each of which illuminating an illuminated area on said screen;
whereby said light sources are positioned so that said illuminated areas generated by light sources adjoining one another are overlapping and thus create an overlapping area, the contact areas between said support elements and said screen being superimposed on said overlapping areas.

2. The device according to claim 1, wherein said screen includes a light diffusion means for diffusing the light emitted by said light sources such that each illuminated area is thus made up of a central illumination area surrounded by a diffusion halo and is created at said diffusion level.

3. The device according to claim 2, wherein said screen includes a transparent portion having a thickness, situated between said support element and said light diffusion means.

4. The device according to claim 4, wherein the thickness of said transparent portion is less than a value eₘₐₓ given by the following relation:
eₘₐₓ=(l+L)cotan(α/2)−h
wherein
h is the shortest distance between the light sources and said transparent portion,
L is the distance between each support element and the nearest light sources,
l is the distance between the middle and the edge of said contact area, and
α is the direct illumination angle of said light sources.

5. The device according to claim 3, wherein:
said transparent portion is a transparent element, such as glass or Plexiglas, including a first and a second face, said contact areas being on the first face of said transparent element, and
said diffusion means is a translucent element, such as a rear projection cloth, situated on said second face of said transparent element.

6. The device according to claim 5, comprising a second transparent element, whereby said diffusion means is situated between said first transparent element and said second transparent element.

7. The device according to claim 1, including at least one holding means for holding said light sources, said holding means being situated at a distance from said support elements and at a distance from said screen, thus defining a space between said holding means and said support elements and between said holding means and said screen, such that the vibrations of said screen are not transmitted to said light sources directly or via said support elements.

8. The device according to claim 6, wherein said holding means for holding said light sources is a panel including said light sources, said panel including through holes for said support elements to pass therethrough.

9. The device according to claim 1 wherein said device is in the shape of a box including walls.

10. The device according to claim 8, wherein said walls include at least one passage to allow cables to pass therethrough.

11. The device according to claim 1, including a control means allowing the parameters of the light emitted by said light sources to be controlled.

12. The device according to claim 10, wherein the structure of said device includes partitions allowing said control means to be separated from the rest of the device.

13. The device according to claim 1, comprising connection means for connecting said device to at least one other said device.

14. An assembly of at least two devices according to claim 1, the devices being in abutment such that the edge of one device is adjacent to the edge of another device, whereby the screens of both devices in abutment constitute a composite screen, the surface of which corresponds to the sum of the surfaces of each screen of each device.

15. The assembly according to claim 13, comprising a global control means which is connected to the whole of the devices of said assembly for controlling all of said devices in order to project an image onto said composite screen.
